(19) United States
(12) Patent Application Publication
(10) Pub. No.: US 2022/0284061 A1
(43) Pub. Date: Sep. 8, 2022

(54) SEARCH SYSTEM AND SEARCH METHOD

(71) Applicant: Hitachi, Ltd., Tokyo (JP)

(72) Inventor: Masafumi TSUYUKI, Tokyo (JP)

(73) Assignee: Hitachi, Ltd., Tokyo (JP)

(21) Appl. No.: 17/480,427

(22) Filed: Sep. 21, 2021

(30) Foreign Application Priority Data
Mar. 2, 2021 (JP) 2021-032786

(51) Int. Cl. G06F 16/903; G06N 20/00

(52) U.S. Cl. CPC G06F 16/90335; G06N 20/00

(57) ABSTRACT

To provide a search system that can easily select a trained model in which an appropriate prediction result is calculated.

A prediction unit executes a prediction by each of a plurality of trained models using test data. A similarity calculation unit calculates similarities between prediction results of the trained models as similarities of the trained models. A grouping unit divides the trained models into groups based on the similarities of the trained models. A summary unit acquires features of the groups based on the prediction results of the trained models belonging to the groups. A selection unit presents information according to the features of the groups.

### BACKGROUND OF THE INVENTION

### 1. Field of the Invention

The present disclosure relates to a search system and a search method.

### 2. Description of the Related Art

In recent years, automation technology using machine learning has attracted attention, and it is also used for, such as detecting an equipment failure in an operation system of factory equipment. For example, equipment that is at a risk of a failure is narrowed down by using a classification model in which time-series numerical data acquired from such as a sensor attached to the equipment is used as an explanatory variable, and a binary label indicating a “normal class” or an “abnormal (failure) class” as an equipment state is used as an objective variable.

In general, supervised learning is used to build a classification model by machine learning. In this case, a large amount of training data exhaustingly including explanatory variables having a data distribution that may be used in an actual prediction and objective variables corresponding to the explanatory variables is required to build a highly versatile classification model. However, in the above example of detecting the equipment failure, since an opportunity of the equipment failure is rare, there is a problem that the large amount of training data having the “abnormal class” as a value of the objective variable cannot be prepared.

In order to solve the above problem, in equipment failure detection, a classification model is usually built by using an anomaly detection task which is a kind of unsupervised learning that does not require an objective variable in training data.

In the anomaly detection task, the training data including only explanatory variables is prepared. Since the opportunity of the equipment failure is rare as described above, the prepared training data can be regarded as data indicating the “normal class”. An anomaly detection model that uses the training data to express the “normal class” is built as the classification model. By using the anomaly detection model, a distance from a data distribution representing the “normal class” is calculated, and data having a distance greater than or equal to a threshold of the distance from the data distribution representing the “normal class” can be inferred as data belonging to the “abnormal class”.

However, in the anomaly detection model, appropriate values of learning conditions such as a model hyperparameter, a collection period of the training data, and a method for creating a feature value included in the training data are unknown. Therefore, in practice, it is necessary to build a plurality of anomaly detection models while changing the learning conditions, compare the plurality of anomaly detection models with each other, and select an anomaly detection model suitable for an actual environment.

If there are supervised learning-based models, an appropriate trained model can be selected by comparing prediction results of the models and calculating a score such as a recall or an accuracy. However, the anomaly detection task, which is the unsupervised learning, has a problem that it is difficult to calculate a score such as a recall or an accuracy of an objective variable.

For the above problem, a method for visualizing a feature of a trained model and selecting or managing the trained model without depending on the score is proposed.

For example, US 2016/0232457 (Patent Literature 1) discloses a method for visualizing features of trained models by combining structures of the trained models, an importance of a feature value, a partially dependent plot, or the like. Tensorflow Hub, [online], [searched on Dec. 23, 2020], Internet <URL: https://tfhub.dev/tensorflow/lite-model/mnasnet_1.3_224/1/metadata/1> (Non-Patent Literature 1) discloses a method for creating trained models and a method for searching for the trained models by using meta information such as a name of training data and a target task. Craven, M and Shavlik, W. “Extracting tree-structured representations of trained networks”, Advances in Neural Information Processing Systems 8, pp. 24-30, 1996 (Non-Patent Literature 2) discloses a method for generating a highly readable rule set by approximating trained models with a decision tree and presenting features of the models.

However, in the technique described in Non-Patent Literature 1, since the trained models are managed based on the meta information, it is impossible to compare prediction results of the trained models, and there is a problem that it is difficult to select the trained model in which an appropriate prediction result is calculated. In the techniques described in Patent Literature 1 and Non-Patent Literature 1, since a plurality of graphs or rules are visualized for each of the trained models, there is a problem that a comparison work becomes inefficient when the number of trained models to be compared is large.

### SUMMARY OF THE INVENTION

An object of the disclosure is to provide a search system and a search method capable of easily selecting a trained model in which an appropriate prediction result can be calculated.

A search system according to an aspect of the disclosure includes: a prediction unit that executes a prediction by each of a plurality of trained models using test data; a similarity calculation unit that calculates similarities between prediction results of the trained models as similarities of the trained models; a grouping unit that divides the individual trained model into groups based on the similarities of the trained models; a summary unit that acquires features of the groups based on the prediction results of the trained models belonging to the groups; and a selection unit that outputs information according to the features of the groups.

According to the invention, a trained model in which an appropriate prediction result is calculated can be easily selected.

### BRIEF DESCRIPTION OF THE DRAWINGS

FIG. 1 is a diagram showing a configuration example of a trained model search system according to an embodiment of the present disclosure.

FIG. 2 is a diagram showing an example of a hardware configuration of a trained model search server.

FIG. 3 is a diagram showing a configuration example of a model information DB.

FIG. 4 is a diagram showing a configuration example of search query information.

FIG. 5 is a diagram showing a configuration example of search result information.

FIG. 6 is a diagram showing a configuration example of prediction result information.

FIG. 7 is a diagram showing a configuration example of similarity information.

FIG. 8 is a diagram showing a configuration example of group information.

FIG. 9 is a diagram showing a configuration example of summary information.

FIG. 10 is a diagram showing a configuration example of explanation information.

FIG. 11 is a diagram showing an example of a model selection screen.

FIG. 12 is a diagram showing an example of a model explanation screen.

FIG. 13 is a diagram showing an example of a model search screen.

FIG. 14 is a flowchart for illustrating operations of the trained model search system.

### DESCRIPTION OF THE PREFERRED EMBODIMENTS

Hereinafter, an embodiment of the disclosure will be described with reference to the drawings.

### (System Configuration)

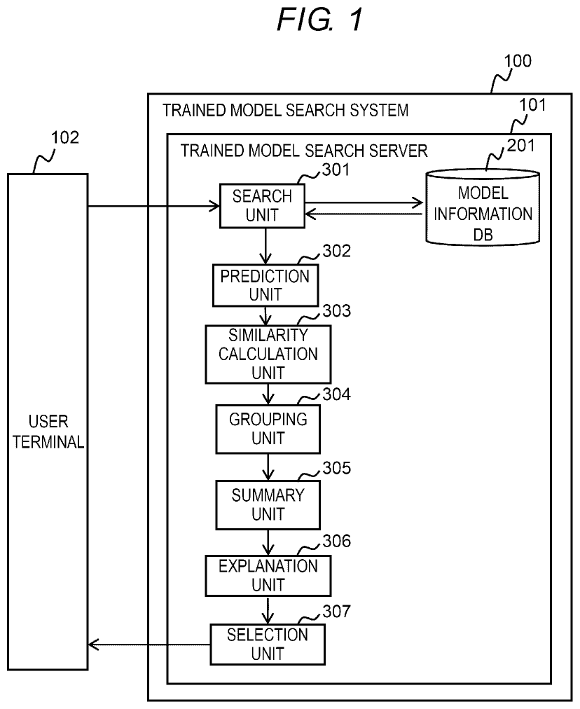

FIG. 1 is a diagram showing a configuration example of a trained model search system according to an embodiment of the present disclosure. A trained model search system 100 shown in FIG. 1 includes a trained model search server 101. The trained model search server 101 is communicably connected to a user terminal 102 used by an operator of the trained model search system 100. The trained model search server 101 and the user terminal 102 may be connected to each other via a communication network such as the Internet.

The trained model search server 101 includes a search unit 301, a prediction unit 302, a similarity calculation unit 303, a grouping unit 304, a summary unit 305, an explanation unit 306, and a selection unit 307.

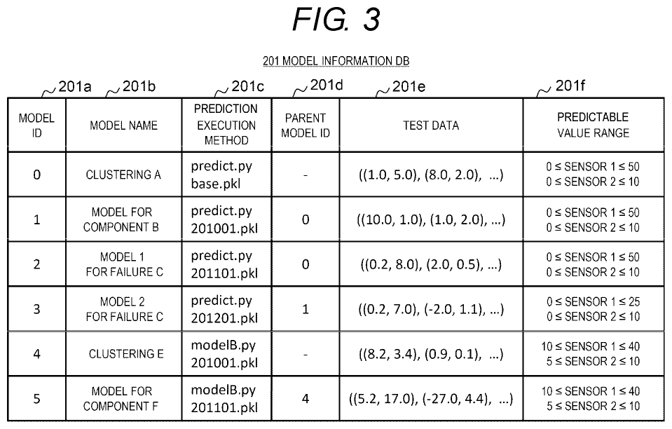

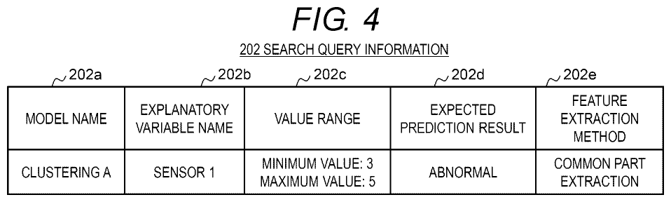

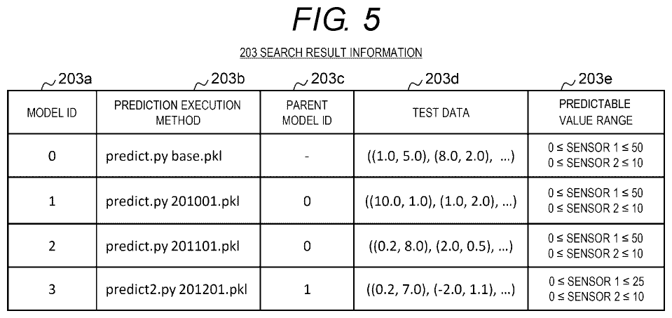

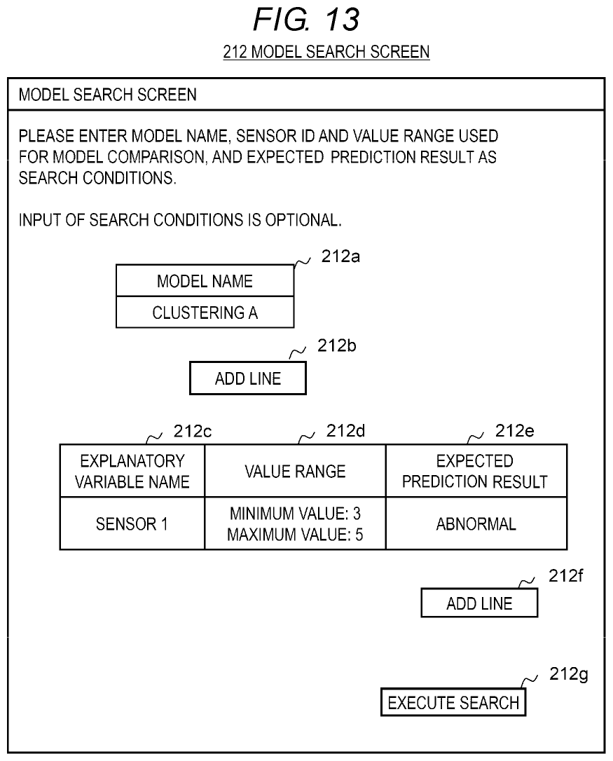

The search unit 301 presents, to the user terminal 102, a model search screen 212 (see FIG. 13) that narrows down model information of target models that are trained models to be processed by the trained model search system 100 from a model information database (DB) 201 (see FIG. 3) that shows model information about each of trained models. The search unit 301 narrows down the model information from the model information DB 201 based on search query information 202 (see FIG. 4) input from the user terminal 102 by the model search screen 212 and generates search result information 203 (see FIG. 5) including the narrowed-down model information.

The trained model is a machine learning model and can be built by supervised learning or unsupervised learning. The trained model is, for example, a classification model in which an explanatory variable is input and is classified into a class indicated by an objective variable. An algorithm for building the classification model is, for example, K-Means clustering, a decision tree, a random forest, a support-vector machine, and the algorithm suitable for a classification target is appropriately selected. The trained model is not limited to the classification model and may be another model.

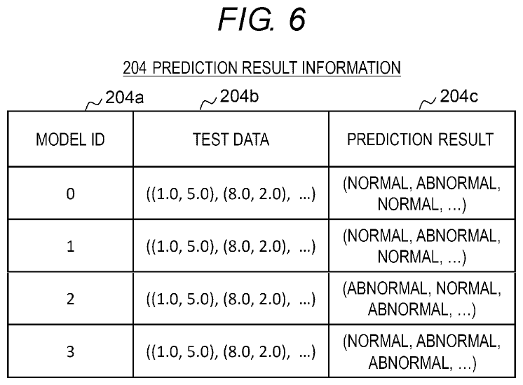

The prediction unit 302 executes a prediction by the target models according to the search result information 203 using predetermined test data, and generates prediction result information 204 (see FIG. 6) indicating prediction results of the target models.

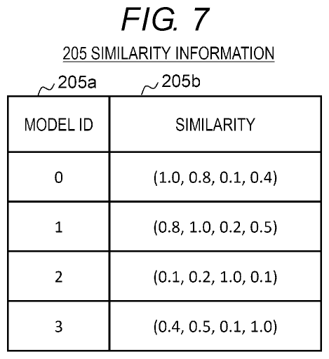

The similarity calculation unit 303 calculates similarities between the target models based on the prediction result information 204, and generates similarity information 205 (see FIG. 7) indicating the similarities of the target models. Specifically, the similarity is for a data distribution of the prediction results of the target models, and can be calculated by a well-known method using a Kullback-Leibler information amount, a Jensen-Shannon information amount, a Jaccard coefficient, or the like.

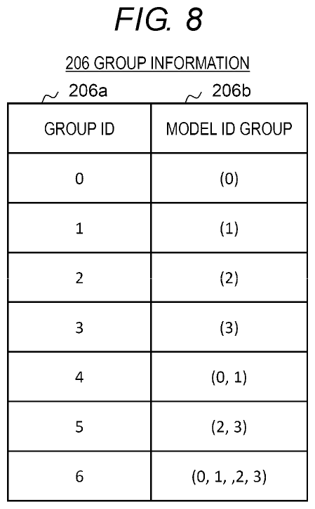

The grouping unit 304 divides the target models into groups based on the similarity information 205, and generates, for each of the groups, group information 206 (see FIG. 8) indicating the target models belonging to the group. It is assumed that the groups have a hierarchical structure and only one target model belongs to the lowest group.

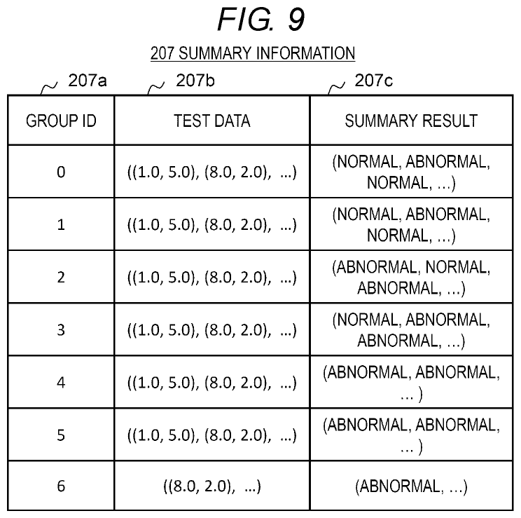

The summary unit 305 acquires features of the groups based on the prediction results of the target models belonging to the groups shown in the group information 206, and generates summary information 207 (see FIG. 9) showing the features of the groups. Specifically, the feature of each of the groups indicates a relation between values of the test data and the prediction results in the target models belonging to the group. More specifically, the feature of each of the groups indicates a “common part” which is a value of the test data in which the prediction results match, or a “difference” which is a value of the test data in which the prediction results are different. Whether to extract the “common part” or the “difference” as the feature of each of the groups is specified by the user, for example.

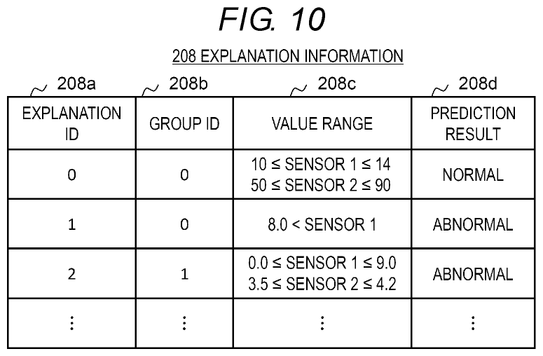

By learning the decision tree based on the summary information 207, the explanation unit 306 generates explanation information 208 (see FIG. 10) that explains the features, as information according to the features of the groups.

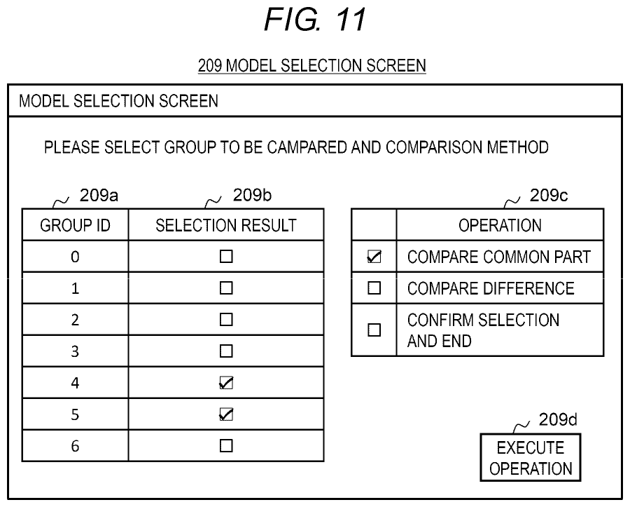

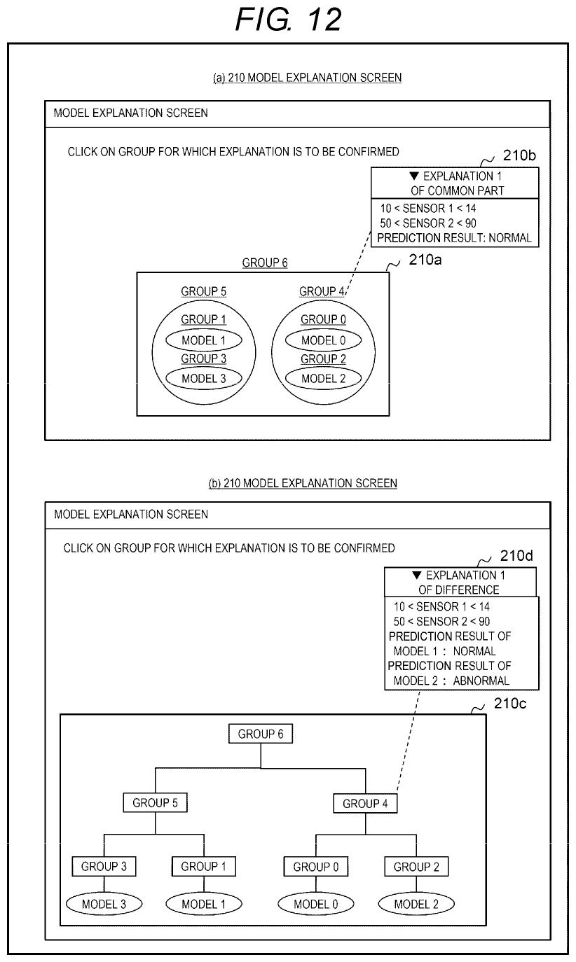

The selection unit 307 displays, on the user terminal 102, a model explanation screen 210 (see FIG. 12) including the group information 206 and the explanation information 208 and a model selection screen 209 (see FIG. 11) prompting the user to select a group and present the model explanation screens 210 and 209 to the operator, and prompts the user to select a group. When a group is selected, the selection unit 307 displays, on the user terminal 102, the model selection screen 209 and the model explanation screen 210 corresponding to a subgroup which is a subset of the target models belonging to the selected group, and prompts the user to select a subgroup. The selection unit 307 can repeat the above process until the number of the target models included in the group (subgroup) becomes one.

### (Hardware Configuration)

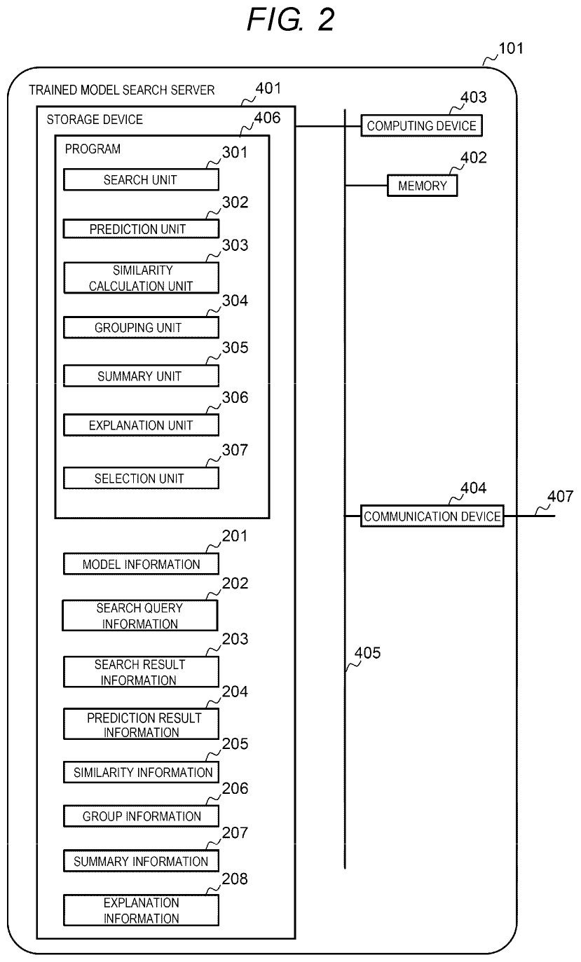

FIG. 2 is a diagram showing an example of a hardware configuration of the trained model search server 101.

As shown in FIG. 2, the trained model search server 101 includes a storage device 401, a memory 402, a computing device 403, and a communication device 404, and the devices are connected to each other via a bus 405.

The storage device 401 is configured with a non-volatile memory element such as a solid state drive (SSD) and a hard disk drive. The storage device 401 stores a program 406 that defines an operation of the computing device 403 and various kinds of information 201 to 208 used or generated by the computing device 403. The memory 402 is configured with a volatile memory element such as a random access memory (RAM).

The computing device 403 is configured with a processor such as a central processing unit (CPU). The computing device 403 reads the program 406 stored in the storage device 401 into the memory 402 and executes the program to implement the units 301 to 307 shown in FIG. 1. The communication device 404 communicates with an external device such as the user terminal 102 shown in FIG. 1 via a network 407.

### (Data Structure)

FIG. 3 is a diagram showing a configuration example of the model information DB 201. The model information DB 201 shown in FIG. 3 includes fields 201a to 201f.

The field 201a stores a model ID that is identification information for identifying a trained model. The model ID may be, for example, a numerical value or a character string. The field 201b stores a highly readable model name for a user to identify the trained model. The field 201c stores prediction execution method information indicating a method for executing the trained model as a program to perform prediction. The prediction execution method information indicates a file for executing the trained model as the program in the example of FIG. 3, but is not limited to this example.

The field 201d stores a parent model ID which is a model ID that identifies a related model that is related to the trained model and is a trained model. The parent model ID indicates a relevance of the learning models. The related model is, for example, a model having an algorithm the same as and a training data period different from the trained model. In the example of FIG. 3, a trained model generated by changing a period of training data from an original trained model is called a child model, the original trained model is called a parent model, and the parent model is the related model.

The field 201e stores, as test data, a set of explanatory variables of training data used for building the trained model. In the example of FIG. 3, the test data is vector data having a numerical value as an element. More specifically, the test data is time-series data having a set of measured values of two sensors 1 and 2 as the elements. However, the test data is not limited to this example, and may be in another format such as a character string, an image, or a voice. The field 201f stores an inferable range, which is a range of explanatory variables that can be inferred by the trained model. Ranges of the explanatory variables that configure the test data are included in the inferable range.

FIG. 4 is a diagram showing a configuration example of search query information. The search query information 202 shown in FIG. 4 includes fields 202a to 202e.

The field 202a stores, as specified information for specifying a target model, a model name of a trained model to be specified as the target model.

The field 202b stores an explanatory variable name, which is a name of the explanatory variable, as information for specifying an explanatory variable used in the test data that is used in the prediction by the prediction unit 302. Here, as the explanatory variable name, a name of a sensor that acquires a measured value as an explanatory variable is used. The field 202c stores a value range as information for specifying the value range which is a range of the explanatory variables used in the test data that is used in the prediction by the prediction unit 302.

The field 202d stores an expected prediction result, which is a prediction result expected when the prediction by the trained model is executed by using, as test data, a subset of a feature value space indicated by the explanatory variable name and the value range. In the present embodiment, the prediction result is a highly readable class name indicating a class to which the test data is classified, and indicates “abnormal” or “normal”. However, the prediction result is not limited to the class name, and may be a numerical value that identifies a class, a classification probability of each class, a regression value, or the like.

The field 202e stores a feature value extraction method information indicating a method for extracting a feature value as information for specifying a feature of a group. The feature value extraction method information indicates a “common part extraction” in which the “common part” of the prediction results is extracted or a “difference extraction” in which the “difference” of the prediction results is extracted. The fields of the search query information 202 can be empty.

FIG. 5 is a diagram showing a configuration example of the search result information 203. The search result information 203 shown in FIG. 5 includes fields 203a to 203e.

The field 203a stores a model ID for identifying each of the target models which are the trained models narrowed down by the search unit 301. The field 203b stores prediction execution method information of the target models. The field 203c stores the parent model IDs of the target models. The field 203d stores the test data corresponding to the target models. The field 203e stores the inferable value ranges of the target models. The inferable value ranges are determined according to the test data.

FIG. 6 is a diagram showing a configuration example of the prediction result information 204. The prediction result information 204 shown in FIG. 6 includes fields 204a to 204c.

The field 204a stores the model IDs of the inferred target models. The field 204b stores the test data used for the prediction by the target models. The field 204c stores the prediction results acquired by the target models using the test data. The prediction results indicate, for each of the explanatory variables included in the test data, the class names which are objective variables corresponding to the explanatory variables.

FIG. 7 is a diagram showing a configuration example of the similarity information 205. The similarity information 205 shown in FIG. 7 includes fields 205a and 205b.

The field 205a stores the model IDs of the inferred target models. The field 205b stores similarities between the target models and other target models. Each of the similarities is vector information and is calculated for all model pairs configured with the target models.

In the example of FIG. 7, since there are four model IDs, the similarity is vector information having a length of 4. For example, when the four model IDs are “0” to “3”, similarity information corresponding to the model ID “0” is information having, as vector elements, a similarity between a target model with the model ID “0” and a target model with the model ID “0”, a similarity between the target model with the model ID “0” and a target model with the model ID “1”, a similarity between the target model with the model ID “0” and a target model with the model ID “2”, and a similarity between the target model with the model ID “0” and a target model with the model ID “3”.

FIG. 8 is a diagram showing a configuration example of the group information 206. The group information 206 shown in FIG. 8 includes fields 206a and 206b.

The field 206a stores a group ID which is identification information for identifying the group of the target models. The group ID may be, for example, a numerical value or a character string. The field 206b stores a model ID group which is a list of the model IDs of the trained models belonging to the group identified by the group ID. The model ID group is vector information having the model ID as the element and having a length of one or more.

FIG. 9 is a diagram showing a configuration example of the summary information 207. The summary information 207 shown in FIG. 9 includes fields 207a to 207c.

The field 207a stores the group IDs. The field 207b stores feature test data, which is the test data, as feature data indicating the features of the groups identified by the group IDs. The field 207c stores summary results, which are the prediction results corresponding to the feature test data.

FIG. 9 shows an example in which the “common parts” are extracted as the features of the groups. In this case, the feature test data is the test data in which the prediction results match in all the target models belonging to the group, among the test data used for the prediction. In this case, each of the summary results shows one prediction result for each of the explanatory variables that configure the feature test data.

When the “differences” are extracted as the features of the groups, the feature test data is test data in which at least any one of the target models belonging to the group has prediction results different from those of the other target models, among the test data used for the prediction. In this case, each of the summary results shows the prediction results of the target models belonging to the group for each of the explanatory variables that configure the feature test data. For example, when the group contains the two target models, the summary result shows two values, such as (normal, abnormal), for each feature test data.

FIG. 10 is a diagram showing a configuration example of the explanation information 208. The explanation information 208 shown in FIG. 10 includes fields 208a to 208d.

The field 208a stores an explanation ID which is identification information for identifying an explanation of a feature of a group. The explanation ID may be, for example, a numerical value or a character string. The field 208b stores a group ID of the group. The field 208c stores a value range of feature test data of the group as an explanation for the feature of the group. The field 208d stores a prediction result corresponding to the value range of the feature test data.

FIG. 10 shows an example in which the “common part” is extracted as the feature of the group. In this case, the value range of the feature test data is the range of the test data in which the prediction results match in all the target models belonging to the group, among the test data used for the prediction. In this case, each of the prediction results has a single value of “normal” or “abnormal”. If the “difference” is extracted as the feature of the group, each of the prediction results is vector information having values as many as the number of target models belonging to the group. For example, when there are two target models, each of the prediction results is vector information with a length of 2 such as (normal, abnormal).

### (Screen Configuration)

FIG. 11 is a diagram showing an example of the model selection screen displayed by the selection unit 307. The model selection screen 209 shown in FIG. 11 includes a list 209a of the group IDs, a group selection box 209b, an operation selection box 209c, and an execution button 209d.

The list 209a of the group IDs is included in the group information 206. The group selection box 209b is a box for selecting any one or more of the group IDs in the list 209a. The operation selection box 209c is a box for selecting a process to be executed by the trained model search server 101. The execution button 209d is a button for confirming the process selected in the operation selection box 209c.

In the example of FIG. 11, when “compare common part” of the operation selection box 209c is selected, the “common part extraction” is stored as a feature extraction method of the search query information 202, and when “compare difference” in the operation selection box 209c is selected, the “difference extraction” is stored as the feature extraction method of the search query information 202. When “confirm selection and end” in the operation selection box 209c is selected, it is determined that the selection of the target models is completed, and the process of the trained model search system 100 is ended.

FIG. 12 is a diagram showing a configuration example of the model explanation screen 210.

In an example of (a) of FIG. 12, the model explanation screen 210 includes a group view 210a and an explanation box 210b.

The group view 210a is an aspect for presenting the group information 206 to the user, and shows a hierarchical structure of the groups according to the group information 206 and the target models belonging to the groups by using a Venn diagram used in a set theory and the like. When the group included in the group view 210a is selected by the operator via the user terminal 102, among the explanation information 208n, the information corresponding to the selected group is displayed in the explanation box 210b. For example, when the feature value extraction method of the search query information 202 indicates the “common part”, the value ranges of the feature test data and one prediction result corresponding to the value range are displayed in the explanation box 210b.

In an example of (b) of FIG. 12, the model explanation screen 210 includes a group view 210c and an explanation box 210d.

The group view 210c is an aspect for presenting the group information to the user, and shows a hierarchical structure of the groups according to the group information 206 and the target models belonging to the groups by using a tree diagram. When the group included in the group view 210c is selected by the operator via the user terminal 102, among the explanation information 208, the information corresponding to the selected group is displayed in the explanation box 210d. For example, when the feature value extraction method of the search query information 202 indicates the “difference”, the value ranges of the feature test data and two prediction results corresponding to the value ranges are displayed in the explanation box 210d.

FIG. 13 is a diagram showing a configuration example of the model search screen. The model search screen 212 shown in FIG. 13 includes a model name input column 212a, a model name specified line adding button 212b, an explanatory variable name input column 212c, a value range input column 212d, an expected prediction result input column 212e, an explanatory variable input line adding button 212f, and a search execution button 212g.

The model name input column 212a is a form for specifying the model name of the trained model as information for narrowing down the model information of the target models to be processed from the trained models. The model name specified line adding button 212b is a button for adding the model name input column 212a.

The explanatory variable name input column 212c and the value range input column 212d are forms for inputting information for specifying the test data used for the prediction. Specifically, the explanatory variable name input column 212c is a form for inputting the explanatory variable names of the explanatory variables that configure the test data used for the prediction, and the value range input column 212d is a form for inputting the value range of the explanatory variables. The expected prediction result input column 212e is a form for inputting an expected prediction result when the prediction is performed with the test data specified in the explanatory variable name input column 212c and the value range input column 212d.

The explanatory variable input line adding button 212f is a button for adding an explanatory variable input line (the explanatory variable name input column 212c, the value range input column 212d, and the expected prediction result input column 212e). The search execution button 212g is a button for executing a search for model information. When the search execution button 212g is pressed, the user terminal 102 transmits the search query information 202 including information input in the input columns 212a and 212c to 212e to the trained model search server 101.

The model search screen 212 may further include a form for inputting the feature extraction method.

### (Process Flow)

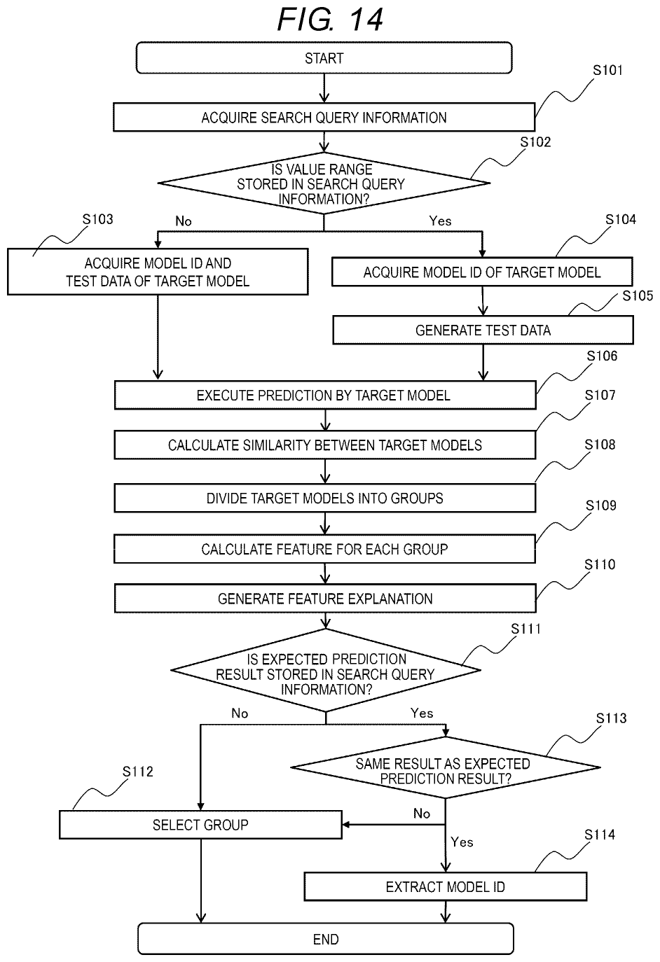

FIG. 14 is a flowchart for illustrating operations of the trained model search server 101.

First, the search unit 301 of the trained model search server 101 displays the model search screen 212 on the user terminal 102, and acquires, from the user terminal 102, the search query information 202 based on the input to the model search screen 212 (step S101). The search unit 301 confirms whether the value range is stored in the search query information 202 (step S102).

When the value range is not stored in the search query information 202, the search unit 301 selects, from the model information DB 201, the trained model that matches the search query information 202 as the target model. The search unit 301 acquires the model ID and the test data of the target model from the model information DB, and generates the search result information 203 including the acquired model ID and test data (step S103). The search unit 301 may further acquire the prediction execution method, the parent model ID, and the inferable value range of the target model.

The target model (the trained model that matches the search query information 202) is specifically a trained model corresponding to the model name stored in the search query information 202. When the parent model ID having the same value as the model ID of the target model is stored in the model information DB 201, the search unit 301 also selects the trained model identified by the parent model ID as the target model. When the model name is not stored in the search query information 202, the search unit 301 selects the trained models of all the model IDs in the model information DB 201 as the target models.

When the value range is stored in the search query information 202, the search unit 301 selects, from the model information DB 201, the trained model that matches the search query information 202 as the target model. The search unit 301 acquires the model ID of the target model from the model information DB, and generates the search result information 203 including the acquired model ID (step S104). The search unit 301 may further acquire the prediction execution method, the parent model ID, and the inferable value range of the target model.

Then, the search unit 301 generates test data in which values corresponding to a plurality of lattice points set in the value range stored in the search query information 202 are used as explanatory variables, and adds the test data to the search result information 203 (step S105). Intervals between the lattice points are, for example, equal intervals, which may be predetermined or may be specified by the user.

When the model name is not stored in the search query information 202 in step S104, the search unit 301 selects the trained models of all the model IDs in the model information DB 201 as the target models, and acquires the model IDs and the test data of the target models from the model information DB 201. In this case, the process of step S105 is skipped.

When step S103 or S105 is ended, the prediction unit 302 executes the prediction by the target model for each of the target models based on the search result information 203, and generates the prediction results as the prediction result information 204 (step S106). The test data used for the prediction is data acquired by merging (logical sum calculation) the test data included in the search result information 203. As a result, the test data corresponding to the inferable value range of the model information DB is generated.

Subsequently, the similarity calculation unit 303 calculates, based on the prediction result information 204, a similarity of the prediction results of the two target models in the model pair for each model pair which is a set of the two target models, and generates the similarity information 205 indicating the similarity of each model pair (step S107).

The grouping unit 304 divides the target models into groups based on the similarity information 205, and generates, for each of the groups, the group information 206 (see FIG. 8) indicating the target models belonging to the group (step S108). The group division can be performed by a known clustering method based on a distance between data, such as aggregated hierarchical clustering and spectral clustering.

The summary unit 305 compares, for each of the groups, the prediction results of the target models belonging to the group based on the group information 206, and generates the summary information 207 that indicates a comparison result as a feature of the group (step S109). For example, the summary unit 305 calculates the feature of the group according to the feature extraction method included in the search query information 202. In this case, when the feature extraction method in the search query information 202 is empty, the summary unit 305 calculates the feature of the group according to a predetermined feature extraction method (for example, the “common part extraction”).

The explanation unit 306 generates, for each of the groups, the explanation information 208 by learning the decision tree based on the feature test data and the summary result of the summary information 207 (step S110).

The selection unit 307 confirms whether the search query information 202 includes the expected prediction result (step S111).

When the search query information 202 does not include the expected prediction result, the selection unit 307 displays the model selection screen 209 and the model explanation screen 210 on the user terminal 102, and prompts the user to select a group. When the group is selected by the user, the selection unit 307 executes a post-selection process according to the selection result (step S112), and ends the process.

In the post-selection process, for example, the selection unit 307 extracts the information about the group selected from the group information 206 and the explanation information 208, and displays the model explanation screen 210 corresponding to the extracted information on the user terminal 102. In this case, the selection unit 307 may display, on the user terminal 102, the model selection screen 209 and the model explanation screen 210 corresponding to the subgroup which is the subset of the target models belonging to the selected group to prompt the user to select the subgroup. The selection unit 307 can repeat the above process until the number of the target models included in the group (subgroup) becomes one. When a feature extraction method different from the feature extraction method of the current group is selected on the model selection screen 209, the processes of steps S109 and S110 are performed again according to the selected feature extraction method. The post-selection process is not limited to this example, and may be, for example, a process of storing information indicating the selected group in the storage device 401 or the like.

When the search query information 202 includes the expected prediction result, the selection unit 307 confirms whether the group ID of the group matching the expected prediction result is included in the explanation information (step S113). Specifically, the group ID of the group that matches the expected prediction result is the group ID of the group having the same combination of a prediction result and a value range as a combination of the expected prediction result and the value range included in the search query information 202.

When the group ID is not included, the process of step S112 is executed. Meanwhile, when the group ID is included, the selection unit 307 extracts the model IDs of the target models belonging to the group with the group ID from the group information 206 to display the model IDs on the user terminal 102 (step S114), and ends the process.

As described above, according to the present embodiment, the prediction unit 302 executes the prediction by each of the plurality of trained models using the test data. The similarity calculation unit 303 calculates the similarities between the prediction results of the trained models as similarities of the trained models. The grouping unit 304 divides the trained models into groups based on the similarities of the trained models. The summary unit 305 acquires the features of the groups based on the prediction results of the trained models belonging to the groups. The selection unit 307 presents the explanation information according to the features of the groups. Therefore, the trained models are divided into groups based on the similarities between the prediction results of the trained models, and the explanation information according to the features of the groups is presented, and thus it is unnecessary to visualize a plurality of graphs or rules for each of the trained models, and the trained model in which an appropriate prediction result is calculated can be easily selected.

In the present embodiment, the features of the groups indicate the relations between the values of the test data and the values of the prediction results in the trained models belonging to the group. For example, the features of the groups indicate the values of the test data in which the prediction results of the trained models belonging to the group match, or the values of the test data in which the prediction results of the trained models belonging to the group are different. In this case, the features of the groups can be made to more appropriately reflect the prediction results, so that the trained model in which the appropriate prediction result is calculated can be easily selected.

In the present embodiment, when any one of the groups is selected, the selection unit 307 outputs the explanation information according to the features of the subgroup which is a subset of the trained models belonging to the selected group. Accordingly, the appropriate trained models can be easily narrowed down.

In the present embodiment, the group having the feature that matches the expected prediction result is presented. Therefore, the trained model in which the appropriate prediction result is calculated can be easily selected.

In the present embodiment, the test data is generated based on the inferable value range, which is the range of explanatory variables that can be inferred in the trained models. Therefore, the prediction can be performed with appropriate test data.

In the present embodiment, the test data is generated based on the specified value range specified in the search query information 201. Therefore, the prediction can be performed with desired test data.

In the present embodiment, the target models are narrowed down from the plurality of trained models based on the parent model IDs in the model information DB and the model names in the search query information. Therefore, the processing load can be reduced.

The embodiment of the disclosure described above is an example for explaining the disclosure, and the scope of the disclosure is not intended to be limited only to those embodiments. A person skilled in the art can implement the disclosure in various other embodiments without departing from the scope of the disclosure.

What is claimed is:

1. A search system, comprising:
a prediction unit configured to execute an prediction by each of a plurality of trained models using test data;
a similarity calculation unit configured to calculate a similarity between prediction results of the trained models as a similarity of the trained models;
a grouping unit configured to divide the trained models into groups based on the similarity of the trained models;
a summary unit configured to acquire features of the groups based on the prediction results of the trained models belonging to the groups; and
a selection unit configured to present information according to the features of the groups.

2. The search system according to claim 1, wherein
the features indicate relations between a value of the test data and values of the prediction results in the trained models belonging to the groups.

3. The search system according to claim 2, wherein
the features indicate the value of the test data in which the prediction results of the trained models belonging to the groups match.

4. The search system according to claim 2, wherein
the features indicate the value of the test data in which the prediction results of the trained models belonging to the groups are different.

5. The search system according to claim 1, wherein
when any one of the groups is selected, the selection unit outputs information according to a feature of a subgroup which is a subset of the trained models belonging to the selected group.

6. The search system according to claim 1, further comprising:
a search unit configured to accept an expected prediction result which is a prediction result expected by the prediction, wherein
the selection unit presents a group having the feature according to the expected prediction result.

7. The search system according to claim 1, further comprising:
a search unit configured to generate the test data according to an inferable value range, which is a range of explanatory variables capable of being inferred in the trained models.

8. The search system according to claim 1, further comprising:
a search unit configured to accept a specified value range, which is a range of explanatory variables for the prediction in the trained models, wherein
the prediction unit generates the test data based on the specified value range.

9. The search system according to claim 1, further comprising:
a search unit configured to narrow down target models that are target trained models from the plurality of trained models based on model information indicating a relevance of the plurality of trained models and specified information for specifying any one of the plurality of trained models, wherein
the prediction unit executes the prediction by the target models.

10. A search method performed by a search system, comprising:
executing prediction by each of a plurality of trained models using test data;
calculating a similarity between prediction results of the trained models as a similarity of the trained models;
dividing the trained models into groups based on the similarity of the trained models;
acquiring features of the groups based on the prediction results of the trained models belonging to the groups; and
outputting information according to the features of the groups.
